(19) United States
(12) Patent Application Publication
(10) Pub. No.: US 2020/0225941 A1
(43) Pub. Date: Jul. 16, 2020

(54) METHOD FOR CREATING RUN-TIME EXECUTABLES FOR DATA ANALYSIS FUNCTIONS

(71) Applicant: INTERNATIONAL BUSINESS MACHINES CORPORATION, ARMONK, NY (US)

(72) Inventors: Martin Oberhofer, Sindelfingen (DE); Mike W. Grasselt, Leinfelden-Echterdingen (DE); Yannick Saillet, Stuttgart (DE); Jens P. Seifert, Gaertringen (DE)

(21) Appl. No.: 16/247,734

(22) Filed: Jan. 15, 2019

(51) Int. Cl. G06F 8/76; G06F 9/455; G06F 8/75; G06F 8/41

(52) U.S. Cl. CPC G06F 8/76; G06F 9/45516; G06N 20/00; G06F 8/43; G06F 8/75

(57) ABSTRACT

The present disclosure relates to a method for creating run-time executables for data analysis functions. The method comprises in response to receiving a data analysis request from a user, selecting from a repository a repository of data analysis functions a set of data analysis functions for execution in a hosting environment or on premises of the user. Usage conditions of the set of data analysis functions by the user may be determined. An additional code for applying the determined usage conditions may be created. The selected data analysis functions and the additional code may be compiled, resulting in an executable code. The executable code may be certified. The certified executable code may be deployed or provided for download to a run-time environment for certified executable codes.

### BACKGROUND

The present invention relates to the field of digital computer systems, and more specifically, to a method for creating run-time executables for data analysis functions.

With the rise of cloud computing, workloads can be moved to cloud computing infrastructures such as IBM cloud. However, moving data to a cloud infrastructure can be problematic due to the data gravity issue. Data gravity indicates how easily a data asset can be moved to a cloud solution. The higher the degree of data gravity is, the more difficult it is to move the data to cloud.

### SUMMARY

Various embodiments provide a method for creating run-time executables for data analysis functions, computer system and computer program product as described by the subject matter of the independent claims. Advantageous embodiments are described in the dependent claims. Embodiments of the present invention can be freely combined with each other if they are not mutually exclusive.

In one aspect, the invention relates to a computer implemented method for creating run-time executables for data analysis functions. The method comprises providing a repository of data analysis functions and, in response to receiving a data analysis request from a user, selecting from the repository a set of data analysis functions for execution in a hosting environment or on premises of the user. In addition, the method comprises determining a license of the set of data analysis functions for the user for execution of the set of data analysis functions and creating an additional code for implementing the determined license. Moreover, the method comprises compiling the selected data analysis functions and the additional code, resulting in an executable code, and certifying the executable code. Furthermore, the method comprises deploying the certified executable code or providing the certified executable code for download to a run-time environment for certified executable codes.

According to one embodiment, the method further comprises instrumenting or configuring the executable code for enabling a collection of usage statistics of the selected data analysis functions during execution of the executable code. This may enable to compare, for example, if similar functions behave quite differently in terms of resource consumption. This may enable to suggest data analysis functions based on the usage statistics for further use by the same user or by other users.

According to one embodiment, if according to the license the user is not entitled to use a full functionality of the selected data functions, creating the additional code such that the set of data analysis functions with restricted functionalities. For example, the set of data analysis functions may be used in a sampling mode. In the sampling mode, the user may, for example, run the set of data analysis functions only a small portion of data. In another example, the user may run the set of data analysis functions only for a limited amount of time.

According to one embodiment, the method further comprises receiving user feedbacks on the set of data analysis functions, and using the user feedbacks for updating the repository. This may enable a collaborative approach where different users with different environments provide feedback on the functions. This may enable to build a robust and reliable repository of functions.

According to one embodiment, the selected set of data analysis functions are updated data analysis functions of the repository and/or new added data analysis functions to the repository and/or existing data analysis functions of the repository. A new added analysis function may be a function that is added to the repository in a predefined time period e.g. added last month etc. The existing data analysis function is a function that exists before that predefined time period (e.g. it existed before the last month). The updated function is an existing function that is updated. For example, the user may indicate which type of these three types of functions would like to use for the analysis. This may increase the response accuracy of the computer system to user requests.

According to one embodiment, the received request is indicative of metadata imported from a data source. The metadata is indicative of one or more analysis to be performed on data of the data source. The method further comprises providing the metadata as input to at least one predefined machine learning (ML) model, wherein the selected set of data analysis functions is an output of the at least one machine learning model using as input the metadata and the data analysis functions of the repository. According to one embodiment, the method further comprises upon receiving the request automatically running an analysis to generate further metadata wherein the input further includes the further metadata. This may further increase the accuracy of the present method and thus providing reliable results. The metadata may further comprise usage statistics as generated by the instrumented executable codes, e.g. of other users.

This embodiment may further be advantageous for the following reasons. Due to the rise of self-service capabilities in information management areas such as data integration, master data management and analytics, there is a much higher need to provide an understanding of what the various data assets are semantically. This yields the need to extend technical profiling capabilities (e.g. column analysis, PK discovery, PK-FK analysis) into the semantical profiling capabilities which need to be developed by domain. As a consequence, since no single software provider will be able to develop a library or profiling framework encompassing all possible domains of data for semantic profiling, the profiling framework needs to be extensible for community contribution with an ability to reward contributions. However, it may be very hard for a single individual, e.g. an analyst, to know whether or not a particular semantic profiling library is available raising the need of means for a search and recommendation functionality in an appropriate market place are necessary. It is also possible that different individuals implement for a particular data domain semantical classification functions in parallel with similar but not identical scope. This embodiment for selecting the data analysis functions may solve this problem as it may provide the analysis functions required by a user using the machine learning capabilities. In addition, using the machine learning model may provide an accurate response to user requests. For example, smart recommendations on which analysis functions to be used based on machine-learning enabled assessment of target system metadata may be provided.

For example, the metadata may comprise the name, description, location and owner of a dataset, the name, description and data types of all the data fields of the dataset, eventual tags, terms or annotations made on the dataset by users, the result of an automatic data profiling analysis (e.g. cardinality, data formats, frequent values and other data properties) made on the dataset, and the result of an automatic classification of the data of the dataset. The ML model (or predictive model) may be configured to provide a suggestion according to which: given the nature of the dataset and its data, it may be beneficial for the user to use a particular function on a certain data field of the dataset, which would validate the values of the certain data field e.g. for instance validating the format of US phone numbers. In addition or alternatively, the ML model may recommend to run a standardization rule such as a rule specialized in US post addresses on other columns of the same dataset. In addition or alternatively, the ML model may suggest, given the cardinality of some of the columns of the dataset, that it may be beneficial to run a deduplication of the records of the dataset to eliminate duplicated entries of the dataset.

The machine learning model may, for example, be generated upon training a machine learning algorithm using a predefined training set. The training set may, for example, comprise data analysis functions in association with metadata of data that have been analyzed successfully by these functions in the past.

The at least one machine learning model may be part of the cognitive capabilities that is enabled by the computer system for processing a user asset. For example, the cognitive capabilities may be used to perform the selection of the set of analysis functions that can be used to analyze the user asset. For example, the cognitive capabilities may enable the following:

A selected function of the set of selected functions may, for example, be one or more classifiers e.g. for detecting data of a particular domain. Suggestions or selection of such classifiers may be based on ML patterns on the user asset (e.g. using the metadata and/or values indicative of the user asset). For example, a ML model such as the Naïve Bayes Classification (NBC) model can predict and select a classifier (domain) which may have positive findings on the user asset, although the user did not originally intended to use that classifier.

After defining or selecting one or more given functions of the set of functions, e.g. such as a classifier, other functions may be identified or derived as being necessary for the execution of the given one or more functions, e.g. the other functions may be executed as part of a pre-processing step. For that, ML based suggestions of the pre-processing needed for the user asset may be provided. For example, in order to apply a certain classifier (e.g. the one suggested by the NBC), appropriate transformations may be needed in a pre-processing (string to date, etc.) step of the user asset. For that, a decision tree may, for example, be used such that it can help to assess the probability of making a correct decision on the needed pre- or post-processing.

Other functions may be suggested based on the user request or intend use of the user asset. For example, if the user intends to detect US phone numbers and US addresses in the user asset, the system may suggest an additional classifier to detect US credit card numbers, or a function to standardize US addresses, because usually these functions are often used, by other users, together with the intended used functions. This may be referred to as cross-selling which may be performed using ML models. For example, the Ordinary Least Squares Regression may be applied to the actual usage statistics for analysis functions and create a prediction model.

In the above example, the at least one machine learning model comprises the NBC, decision tree and the Ordinary Least Squares Regression models.

In another example, the selected set of analysis functions may be indicated in the data analysis request received from the user.

According to one embodiment, the run-time environment comprises a container-based runtime environment that is configured to execute only compiled, certified and codes implementing the license.

According to one embodiment, the container-based runtime environment comprises one or more container instances of a container image. For example, the run-time environment may, for example, comprise a Docker container on which the data analysis is to be performed using the selected set of data analysis functions.

According to one embodiment, the determining of the license is based on the user's inputs to the repository, wherein the user inputs comprise further uploaded data analysis functions to the repository, and/or feedbacks of the data analysis functions in the repository and/or changes to the data analysis functions in the repository. For example, the more the user has contributed to the content of the repository the better the license or usage conditions are e.g. the user may have a longer time period for executing the selected set of data analysis functions.

According to one embodiment, the method further comprises in response to receiving a user input comprising a piece of code, running a similarity check for determining if the received piece of code is not a duplicate of an existing code of the repository; and based on the result of the comparison defining or updating the license for the user. If someone tries to get license entitlements by making library contributions through “misuse” by copying a library function, making a code comment change and adding it as a different function—this embodiment may detect that these two codes are too similar on code level and would flag the new function as a likely copy cat function with malicious intent.

According to one embodiment, the certifying is performed using a certificate-based digital signature to sign the executable code.

According to one embodiment, the method further comprises receiving from the user data indicative of the run-time environment, wherein the compiling is performed in response to receiving that data.

According to one embodiment, the data analysis functions comprise data classifiers or data rules.

In another aspect, the invention relates to a computer program product comprising a computer-readable storage medium having computer-readable program code embodied therewith, the computer-readable program code configured to implement all of steps of the method according to preceding embodiments.

In another aspect, the invention relates to a computer system for creating run-time executables for data analysis functions. The computer system is configured for, in response to receiving a data analysis request from a user, selecting from a repository of data analysis functions a set of data analysis functions for execution in a hosting environment or on premises of the user. In addition, the computer system is configured for determining a license of the set of data analysis functions for the user for execution of the set of data analysis functions and creating an additional code for applying the determined license. Moreover, the computer system is configured for compiling the selected data analysis functions and the additional code, resulting in an executable code, and certifying the executable code. Furthermore, the computer system is configured for deploying the certified executable code or providing the certified executable code for download to a run-time environment for certified executable codes.

### BRIEF DESCRIPTION OF THE SEVERAL VIEWS OF THE DRAWINGS

In the following embodiments of the invention are explained in greater detail, by way of example only, making reference to the drawings in which:

FIG. 1 shows an exemplary environment to which the present disclosure can be applied, in accordance with an embodiment of the present disclosure.

FIG. 2 depicts a diagram of a cloud site in connection with multiple premises.

FIG. 3 depicts a diagram of a system for creating an executable in accordance with the present disclosure.

FIG. 4 is a flowchart of a method for creating run-time executables for data analysis functions.

FIG. 5 depicts a cloud computing node according to an embodiment of the present invention.

FIG. 6 depicts a cloud computing environment according to an embodiment of the present invention.

FIG. 7 depicts abstraction model layers according to an embodiment of the present invention.

### DETAILED DESCRIPTION

The descriptions of the various embodiments of the present invention will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Due to the problems related to data movement to the cloud sites, the present disclosure provides a hybrid solution that has the option of not moving data to the cloud site while still making use of the cloud capabilities. The present disclosure enables to manage some data assets on premises and others in the cloud. This may increase the flexibility and efficiency of the hosting environments such as the cloud environment.

However, since services or tools provided by the hosting environment are subject to usage conditions or licenses that would depend on the premises and their users, the present disclosure may have a further advantage of controlling the usage conditions in this hybrid solution, in particular in case the data is processed locally on premises. For example, on premises licensing may be CPU-centric whereas cloud licenses may be based on a subscription basis (e.g. per month with certain volumes, e.g. 500 GB of data). The present disclosure may solve this technical challenge of controlling the resources usage such as the CPU usage and the network bandwidth on an individual basis.

The term “dataset” or “asset” refers to a collection of one or more data elements. A data element may, for example, be a document, a data value, or a data record. For example, the dataset may be provided in the form of a collection of related records contained in a file, e.g. the dataset may be a file containing records of all students in class. A record is a collection of related data items, e.g. roll number, date of birth, a class of a student. A record represents an entity, wherein the entity has a distinct and separate existence, e.g. such as a student. The dataset may, for example, be a table of a database or a file of a Hadoop file system, etc. In another example, the dataset may comprise a document such as a HTML page or other document types. The document may, for example, comprise data of a patient.

The implementing of the license comprises checking predefined usage conditions as determined or defined by the license and enabling the usage of the set of analysis functions only when the usage conditions are fulfilled.

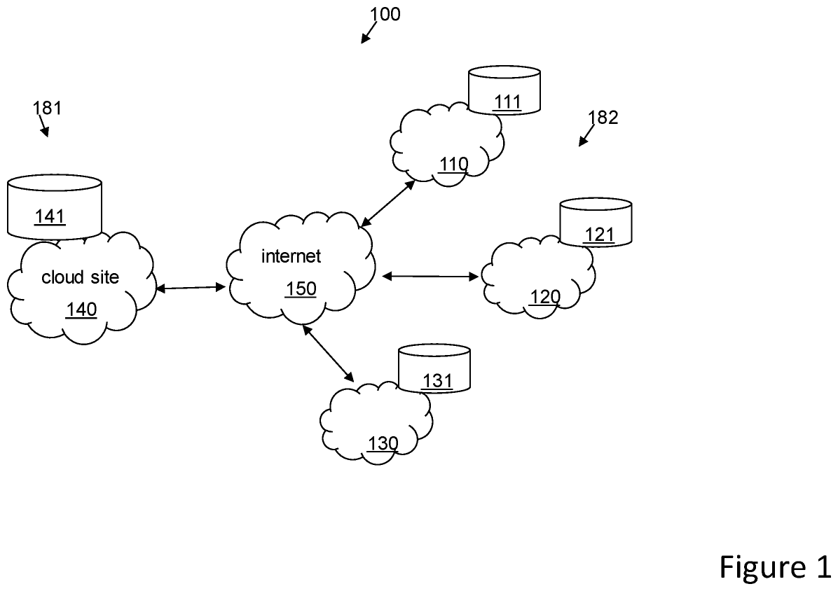

FIG. 1 shows an exemplary environment 100 to which the present disclosure may be applied, in accordance with an example of the present disclosure. The environment 100 includes premises 110, 120, and 130 connected to a cloud site 140 via the Internet 150. The three premises 110, 120, and 130 may be different in that each premise has its own respective dataset 111, 121, and 131. The cloud site 140 also includes a respective dataset 141.

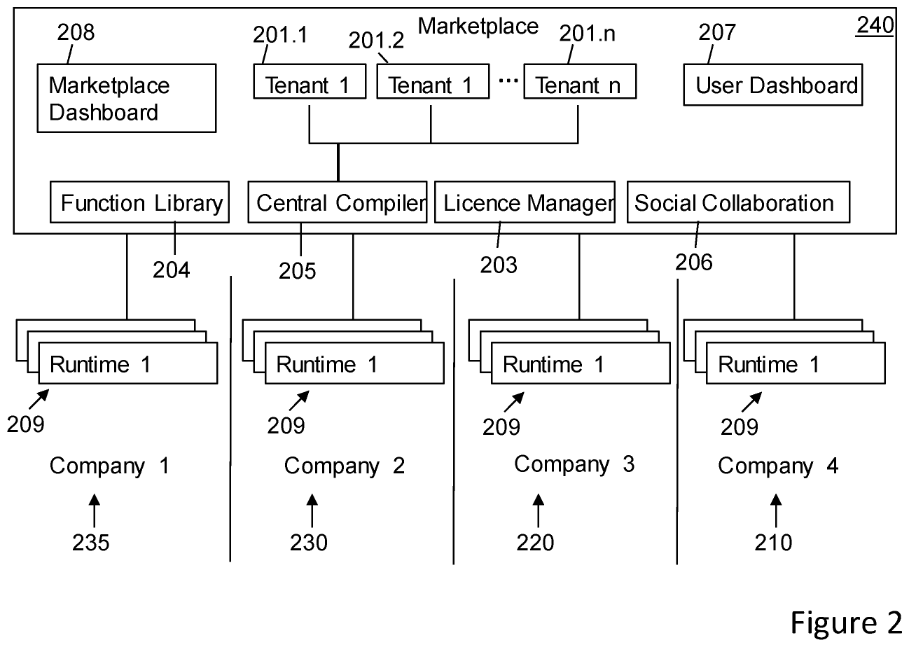

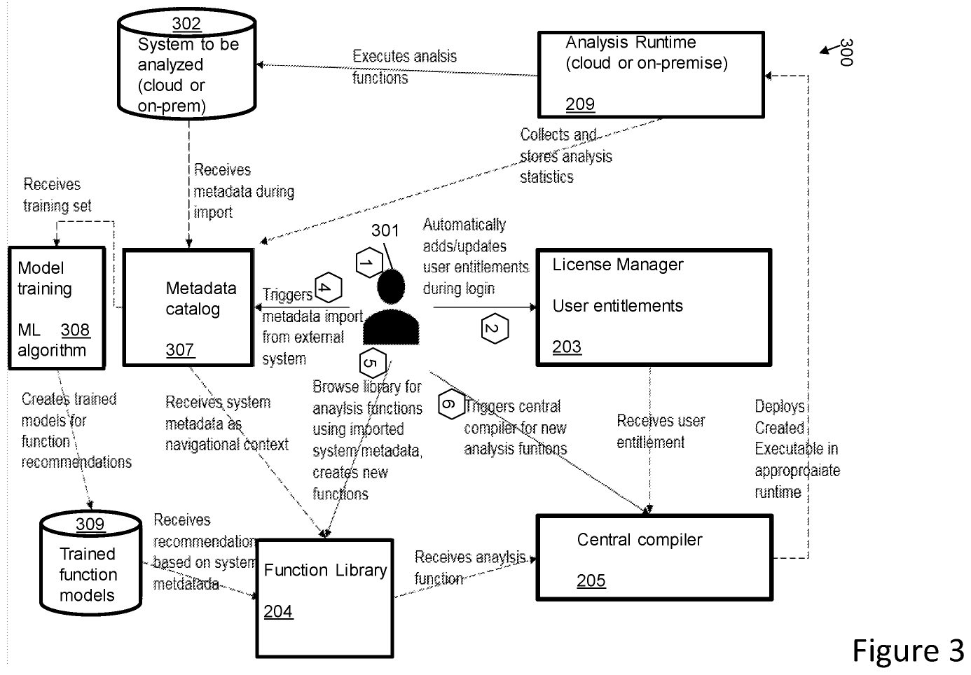

At least part of the present disclosure may, for example, be implemented in the cloud site 140. Accordingly, a cloud site portion 181 and a premise portion 182 are shown in FIG. 1. The cloud site portion 181 may include one or more of the elements shown in FIGS. 2 and 3 and one or more of the premises 111, 120, and 130 may include other ones of the elements shown in FIGS. 2 and 3.

Computing solutions can be developed in the cloud environment. Developing and testing applications such as data classifiers in a single environment is faster and more cost-efficient than developing an application for many different environments. The movement of the datasets 111, 121, and 131 from the premises to the cloud site 140 may not be efficient e.g. due to the data gravity. Therefore, it may be efficient to bring the application over from the cloud and executed on the different premises. That is, the same application may be executed on at least one of the different datasets 111, 121, and 131 at the different premises 110, 120, and 130, respectively. In addition or alternatively, the application may be executed on the cloud site e.g. this may be advantageous if there are shared data between multiple users at the cloud site.

The challenge involved in executing an application developed in one context and have it executed in multiple other contexts may be the lack of appropriate license or usage conditions management that is context dependent, lack of ability to recommend volume pricing adjustments based on the execution context; lack of capability to detect code similarity between two contributions to avoid infringement; lack of discovery of code patterns to improve code templates; lack of data certification and the complexity of the application as it may involve different type of analysis techniques and thus a huge number of libraries and functions that may not be user manageable. The present method may overcome those problems.

FIG. 2 depicts a diagram of a cloud site 240 in connection with multiple premises 210, 220, 230 and 235 in accordance with an example of the present disclosure. The cloud site 240 may comprise a cloud marketplace. The cloud site 240 enables end users to subscribe creating a tenant 201.1-n. The tenant is a user or a unit that is using or enabled to use the services or application of the cloud site 240. The cloud site 240 comprises a license manager 203 enforcing license compliance, optionally with features to grant a new license coverage if a tenant makes regularly and/or substantial function contributions to a common library such as function library 204. Possible license coverage needs may be made cheaper for large volume use. The cloud site 240 may further comprise a verification component (not shown). The verification component may be configured to check codes or functions such as the executable code of step 409 or new codes of a repository such as function library 204. The verification component may be configured perform a static code analysis and/or run some tests in a protected sandbox to ensure that the uploaded function is not doing any harm or unintended effects. The verification component may further be configured to request, from one or more users, user inputs or a confirmation of the added codes or functions.

The cloud site 240 further comprises function library (or repository) 204 that the users can access to determine if for a task of a user (e.g. analysis of a particular source with a particular technique) a function already exists, e.g. alongside feedbacks. The function library 204 also has features for suggesting related functions (e.g. a suggestion may, for example, indicate “another user doing a DW/MDM/SAP/scenario also used these other functions x,y.z”). This may be based on scenario templates grouping functions. The function library 204 also has a machine learning deployed to learn which patterns are commonly used together to suggest new scenario templates. The function library 204 may also have machine learning looking at the target metadata of the source to be analyzed to make suggestions based on target system metadata. For the function library 204, other users can provide recommendations of what should be used, learning paths or recommendations for newbies for data analysis.

The cloud site 240 further comprises a central cloud compiler 205. The central cloud compiler 205 may be configured to compile a new function producing an executable with appropriate license to runtimes 209 of the premises 210, 220, 230 and 235. The central cloud compiler 205 may further be configured to re-compile a function from the function library 204 with appropriate license for the premise runtime 209. If the tenant 201.1-n lacks proper license entitlement for a generated function code, they will only work in sampling mode processing with the function code a very small subset of the data it supposedly processes. Using the central cloud compiler 205, the runtime 209 on the premises can be seamlessly upgraded. This may particularly be advantageous in case the runtime 209 is a JVM container.

The central cloud compiler 205 may be configured to provide certificate creation of compiled code and upgrades of new features. Only certified executables can run on premises, e.g. 210. For example, if someone tries to get license entitlements by making library contributions through “misuse” by copying a library function, making a code comment change and adding it as a different function, the central cloud compiler 205 may detect that these two are too similar on code level and would flag the new function as a likely copy cat function with malicious intent. This may impact the usage conditions or license definition or at least maintaining unchanged the existing usage conditions for such users.

The cloud site 240 further comprises a social collaboration component 206 that may enable the provision of feedbacks on cloud services such as the functions of the function library 204. The social collaboration component 206 may, for example, enable users to tag functions in the function library 204 for increasing or decreasing reputation of function contributors. The social collaboration component 206 may further enable users to qualify satisfaction with results of a function of the function library 204 and differences between similar functions.

The cloud site 240 further comprises a user dashboard 207 that enables a user to review results and see usage behavior e.g. of a function of the function library 204.

The cloud site 240 further comprises a market dashboard 208 that enables marketplace owner to see which functions are most frequently used. The marked dashboard 208 may also enable an aggregated feedback on functions including usage statistics enabling to compare, for example, if similar functions behave quite differently in terms of resource consumption.

As shown in FIG. 2, on premises 210, 220, 230 and 235 there is only a runtime container (or multiple instances of the same container) 209 to execute compiled, certified and licensed code created with the tenant on the cloud site 240 using the central cloud compiler 205.

FIG. 3 depicts a diagram of a system 300 for creating an executable in accordance with the present disclosure. The system 300 may comprise component of the cloud site 240 as described with reference to FIG. 2. Like numbered elements in these figures are either equivalent elements or perform the same function.

A user 301 subscribes to the system 300 by creating a new tenant in step 1 (as illustrated with a polygon). For the new user 301, appropriate entitlements related to the subscription are added in step 2 to the license manager 203. For example, entitlements can be a mix of functional areas, data volume metrics to be analyzed, etc. The registered user 301 may then open, within the tenant, the cloud-based design environment as enabled by the cloud site 240. The user 301 may import metadata in step 4 from a target system 302 for which an analysis may be necessary. The user 301 may then create a new data rule or a new data classifier using the cloud-based design environment or may browse in step 5 the function library 204 using the metadata. In case a function is found in the function library 204, it can be used as starting point for enhancements of the function for enabling the analysis. Note that when navigating to the function library 204, the metadata of the target system 302 is part of the navigational context. This may allow the recommendation of functions based on target system's metadata. The recommendation may, for example, be a machine learning based (ML-based) recommendation.

For example, after importing the metadata from the target system 302 for which an analysis is necessary, cognitive capabilities provided by the system 300 may be used. The cognitive capability of the system 300 may be enabled by components 307-309. The metadata catalog 307 may, for example, be configured to provide training data to a training component 308. The training component 308 may be configured to train one or more machine learning algorithms on the training data to generate prediction models. The generated models may be stored in storage component 309 such that they can be used to provide recommendations based on the imported metadata. For example, cognitive capabilities provided by the system 300 may allow the following interaction of the user 301 and system 300 for creating new data rules for processing new assets. The new rules may be a combination of existing rules of the system 300:

S1. System 300: This is the data classes 1 found for the new assets. There are assets that could either not be classified or need an improved classification algorithm.

S2. User 301: Please create a new classifier request for asset10 and asset11 of the new assets.

S3. User 301: Please make sure all zip codes are valid.

S4. System 300: The following classified assets have been found for zip codes and bound to the listed data quality rules. Please edit the assignment if required. Hint: for this asset type and the related assets, users typically also run the listed address verification and address completeness checks. I did a quick run for your assets and listed the results below where you can also activate the rules for your assets. I also added rules that should be executed per the governance rules that apply to your assets.

S5. User 301: Please validate asset10 with rule1 and map asset10.plz to rule1.zip.

S6. System 300: asset10 has been added to the list of validated assets.

For step S1, the system 300 automatically applied known classifiers and reported results with a very low confidence. Therefore, the user 301 decided to ask the community for a classifier that better fits the new assets in step S2 (in case of sensitive data, the request is sent to a predefined group of experts for this kind of data). For Step S3, the system 300 translates the request into a model that allows identifying assets with data classes having zip codes (using synonyms) and appropriate data quality rules. Because the system 300 already knows (learned from previous runs) about already existing assets with the same data classes and bound data quality (DQ) rules, it can use this information to suggest additional data quality checks. The same translation or suggestion flow can be used to identify required validations based on governance rule descriptions. As a response to the user request (or governance rules), the system 300 can directly run these data quality rules against the new assets (e.g. the system 300 can decide based on operational metadata if and how these rules should be used in an interactive mode) and present the results to the user 301 who can then decide to activate these additional validations for the new assets. In step S5, the user 301 creates a new rule binding and the system can also learn that “plz” is a synonym for “zip”.

Once the user 301 is done with designing the new or updated data rule or classifier (e.g. as exemplified with interaction steps S1-S5), the user 301 provides the details of the execution environment (available either on premises 210-235 or on cloud site 240) and can then trigger a compile operation in step 6 of a code that represents the new or updated rule or classifier of the user 301. In response to the trigger, the central cloud compiler 205 may be configured to perform the following tasks or actions: checking of license entitlement of the user 301; checking, by a code similarity analysis, if the code is a “copy cat” misuse; compiling the code; putting instrumentation in the code for collection of usage statistics; certifying the code; deploying the created executable into runtime 209 for execution; triggering execution and updating a license repository if needed in case there are volume or resource-based license metrics to update the counter indicating how much is left. At execution time, the instrumented code collects usage statistics and returns that information to the cloud-based market dashboard 208. Once results of the data rule or classifier are available, the user 301 can inspect them. The user 301 can then socially collaborate on that function adding tags, etc. to it using the social collaboration 206.

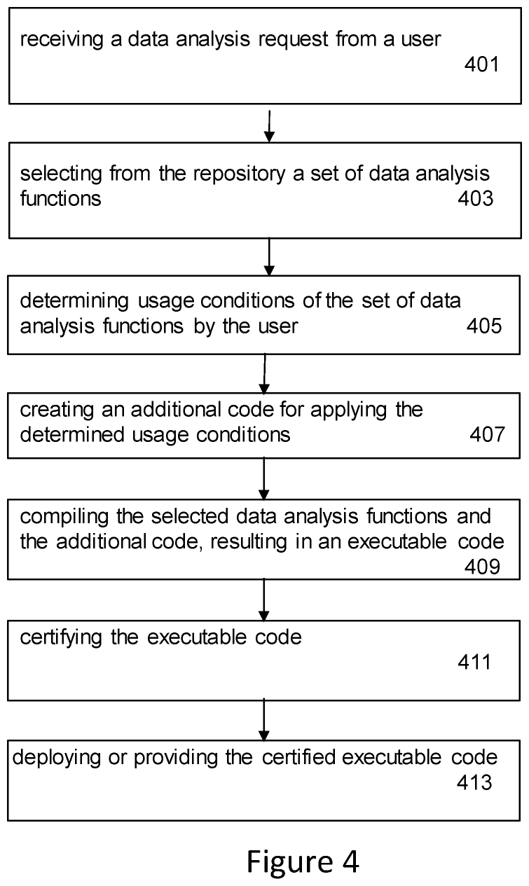

FIG. 4 is a flowchart of a method for creating run-time executables for data analysis functions of a repository e.g. the function library 204.

In step 401, data analysis request may be received by the central cloud compiler 205 from the user 301. For example, the data analysis request may be a request to classify one or more data attributes such as ZIP code, city and color attributes etc. The data analysis request may, for example, comprise metadata indicative of a user system storing data to be analyzed by the user. The user system can, for example, be a hosting environment such as cloud site 240 or a premise such as premise 210. The metadata may, for example, be indicative of the data stored in the user system e.g. indicating which attributes are comprised in the data and what type the data is in the user system. The metadata may further indicate the technical specification or properties of the user system e.g. indicating the run-environment of the user system that enables to compile codes accordingly in order to be executed on the user system. The run-time environment may indicate a configuration of hardware and/or software. It may, for example, include the CPU type, operating system and system software required by a particular category of applications etc.

In response to receiving the data analysis request, the central cloud compiler 205 may select in step 403 from the repository 204 a set of data analysis functions for execution in the user system. Following the example above, the central cloud compiler 205 may select ZIP code classifiers or color classifiers etc. The selection may, for example, use the cognitive capabilities described for the system 300 for selecting the set of data analysis functions.

In step 405, the central cloud compiler 205 may determine usage conditions or a license for usage of the set of data analysis functions by the user. The usage conditions associated to the user may, for example, be determined based on license terms and conditions. For example, if the user has a license for using the selected set of data analysis functions for one year only, the usage conditions may be determined accordingly.

In step 407, an additional code may be created by the central cloud compiler 205 for indicating or reflecting the determined usage conditions. For example, the additional code may limit the duration of usage of the selected analysis function to one year.

In step 409, the central cloud compiler 205 may compile the selected data analysis functions and the additional code, resulting in a piece of executable code. The complication may, for example, be performed based on the technical properties of the user system

In step 411, the central cloud compiler 205 may certify the executable code. The certification of the code may, for example, be performed using a certificate-based digital signature to sign the executable code. For example, the certification may indicate that the code has been profiled or validated by a given library, e.g. library xyz v17 to be compliant with the given library.

In step 413, the central cloud compiler 205 may deploy the certified executable code or provide the certified executable code for download to the user system for certified executable codes.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

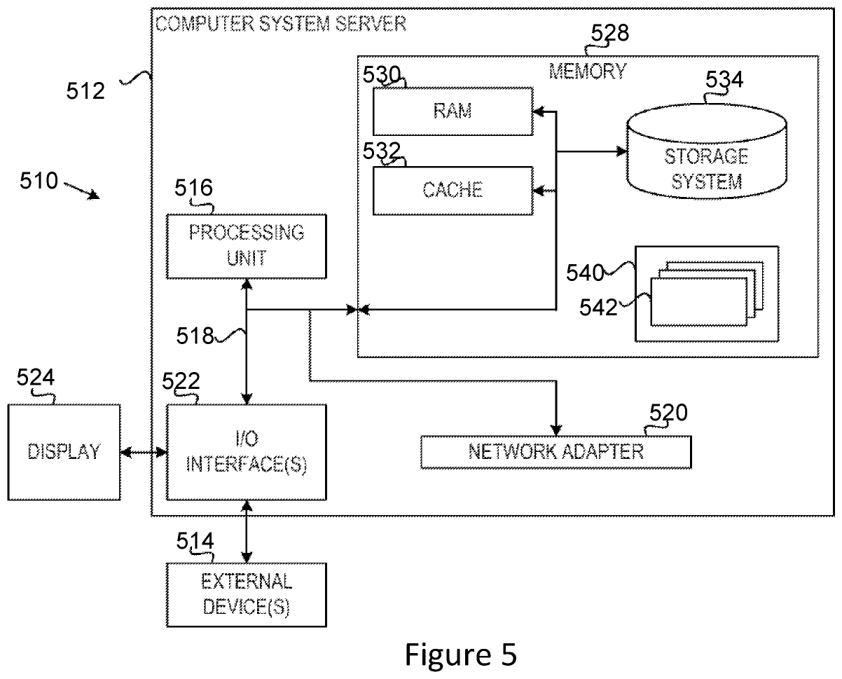

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 510 is capable of being implemented and/or performing any of the functionality set forth hereinabove.

In cloud computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in cloud computing node 10 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 512 typically includes a variety of computer system readable media. Such media may be any available media that is accessible by computer system/server 512, and it includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 512 may also communicate with one or more external devices 514 such as a keyboard, a pointing device, a display 524, etc.; one or more devices that enable a user to interact with computer system/server 512; and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems, etc.

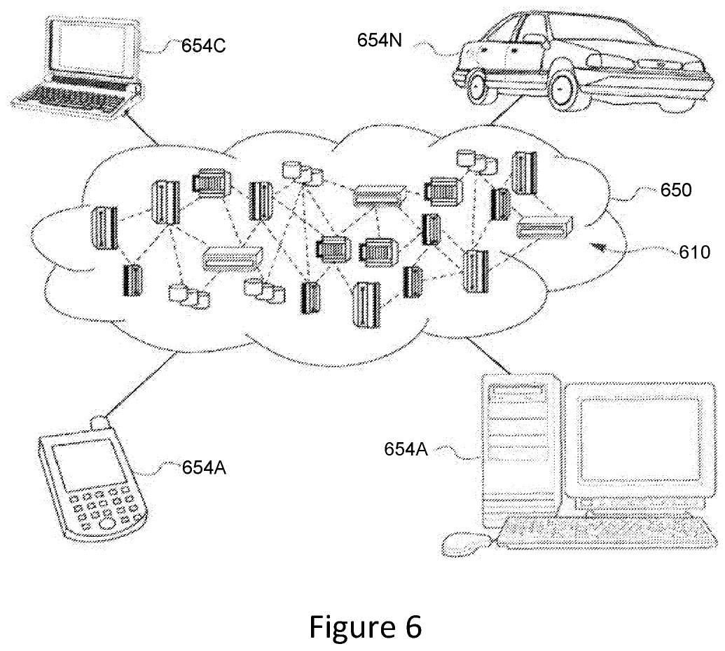

Referring now to FIG. 6, illustrative cloud computing environment 650 is depicted. As shown, cloud computing environment 650 comprises one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 2 are intended to be illustrative only and that computing nodes 610 and cloud computing environment 650 can communicate with any type of computerized device over any type of network and/or network addressable connection (e.g., using a web browser).

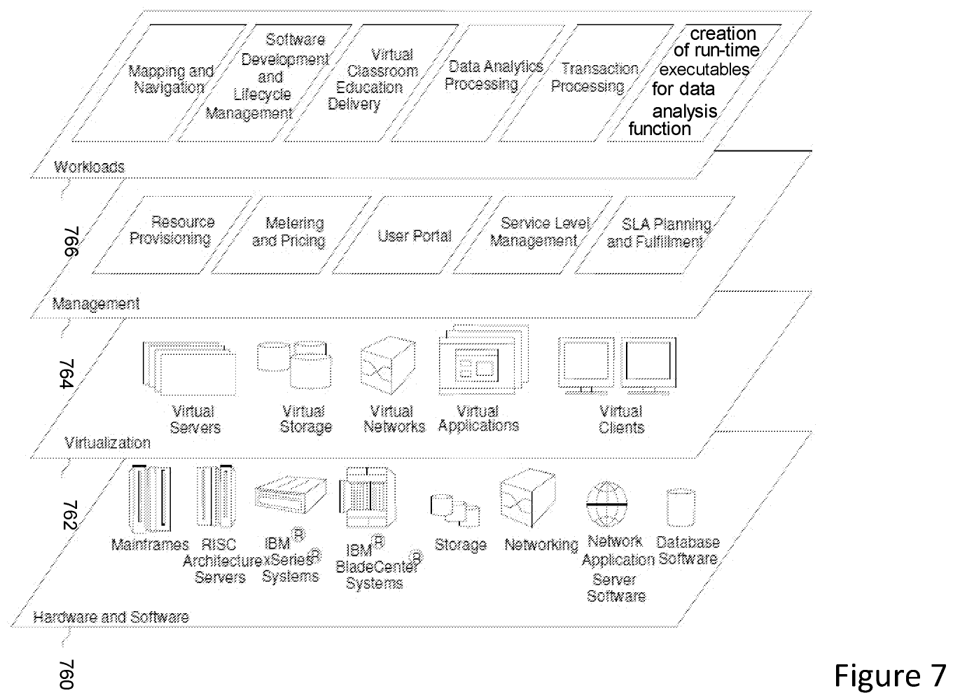

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 762 provides an abstraction layer from which the following examples of virtual entities may be provided: virtual servers; virtual storage; virtual networks, including virtual private networks; virtual applications and operating systems; and virtual clients.

In one example, management layer 764 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 766 provides examples of functionality for which the cloud computing environment may be utilized. Examples of workloads and functions which may be provided from this layer include: mapping and navigation; software development and lifecycle management; virtual classroom education delivery; data analytics processing; transaction processing; and creation of run-time executables for data analysis functions in accordance with the present disclosure.

Various embodiments are specified in the following numbered clauses.

1. A computer implemented method for creating run-time executables for data analysis functions, the method comprising

providing a repository of data analysis functions;
in response to receiving a data analysis request from a user, selecting from the repository a set of data analysis functions for execution in a hosting environment or on premises of the user;
determining a license of the set of data analysis functions for the user for execution of the set of data analysis functions;
creating an additional code for implementing the determined license;
compiling the selected data analysis functions and the additional code, resulting in an executable code;
certifying the executable code;
deploying the certified executable code or providing the certified executable code for download to a run-time environment for certified executable codes.

2. The method of clause 1, further comprising configuring the executable code for enabling a collection of usage statistics of the selected data analysis functions during execution of the executable code.

3. The method of clause 1 or 2, if according to the license the user is not entitled to use a full functionality of the selected data functions, creating the additional code such that the set of data analysis functions are used with restricted functionalities.

4. The method of any of the previous clauses, further comprising: receiving user feedbacks on the set of data analysis functions, and using the user feedbacks for updating the repository.

5. The method of any of the previous clauses, wherein the selected set of data analysis functions are updated data analysis functions of the repository and/or new added data analysis functions to the repository and/or existing data analysis functions of the repository, a new added analysis function being a function that is added to the repository in a predefined time period; an existing data analysis function being a function that exists before that predefined time period; an updated analysis function being an existing function that is updated.

6. The method of any of the previous clauses, the received request being indicative of metadata imported from a data source, the metadata being indicative of one or more analysis to be performed on data of the data source and providing the metadata as input to at least one predefined machine learning model, wherein the selected set of data analysis functions is an output of the at least one machine learning model using as input the metadata and the data analysis functions of the repository.

7. The method of clause 6, further comprising upon receiving the request automatically running an analysis to generate further metadata wherein the input further includes the further metadata.

8. The method of any of the previous clauses, wherein the run-time environment comprises a container-based runtime environment that is configured to execute only compiled codes, certified codes and codes implementing the license.

9. The method of clause 8, wherein the container-based runtime environment comprises one or more container instances of a container image.

10. The method of any of the previous clauses, the determining of the license being performed using the user's inputs to the repository, wherein the user inputs comprise further uploaded data analysis functions to the repository and/or feedbacks of the data analysis functions in the repository and/or changes to the data analysis functions in the repository.

11. The method of any of the previous clauses, further comprising in response to receiving a user input comprising a piece of code, running a similarity check for determining if the received piece of code is not a duplicate of an existing code of the repository; and based on the result of the comparison defining or updating the license for the user.

12. The method of any of the previous clauses, wherein the certifying is performed using a certificate-based digital signature to sign the executable code.

13. The method of any of the previous clauses, further comprising receiving from the user data indicative of the run-time environment, wherein the compiling is performed in response to receiving that data.

14. The method of any of the previous clauses, wherein the data analysis functions comprise data classifiers or data rules.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-14. (canceled)

15. A computer program product comprising a computer-readable storage medium having computer-readable program code embodied therewith, the computer-readable program code configured to perform a method, the method comprising:
providing a repository of data analysis functions;
in response to receiving a data analysis request from a user, selecting from the repository a set of data analysis functions for execution in a hosting environment or on premises of the user;
determining a license of the set of data analysis functions for the user for execution of the set of data analysis functions;
creating an additional code for implementing the determined license;
compiling the selected data analysis functions and the additional code, resulting in an executable code;
certifying the executable code; and
deploying the certified executable code or providing the certified executable code for download to a run-time environment for certified executable codes.

16. The computer program product of claim 1, further comprising configuring the executable code for enabling a collection of usage statistics of the selected data analysis functions during execution of the executable code.

17. The computer program product of claim 1, if according to the license the user is not entitled to use a full functionality of the selected data functions, creating the additional code such that the set of data analysis functions are used with restricted functionalities.

18. The computer program product of claim 1, further comprising receiving user feedbacks on the set of data analysis functions, and using the user feedbacks for updating the repository.

19. The computer program product of claim 1, wherein the selected set of data analysis functions are at least one of updated data analysis functions of the repository, new added data analysis functions to the repository, and existing data analysis functions of the repository, and wherein the new added analysis function is a function that is added to the repository in a predefined time period, the existing data analysis function is a function that existed before that predefined time period; and the updated analysis function is an existing function that is updated.

20. The computer program product of claim 1, wherein the received request is indicative of metadata imported from a data source, and wherein the metadata is indicative of one or more analysis to be performed on data of the data source and providing the metadata as input to at least one predefined machine learning model, and wherein the selected set of data analysis functions is an output of the at least one machine learning model using as input the metadata and the data analysis functions of the repository.

21. The computer program product of claim 6, further comprising, upon receiving the request, automatically running an analysis to generate further metadata, wherein the input further includes the further metadata.

22. The computer program product of claim 1, wherein the run-time environment comprises a container-based runtime environment that is configured to execute only compiled codes, certified codes, and codes implementing the license.

23. The computer program product of claim 8, wherein the container-based runtime environment comprises one or more container instances of a container image.

24. The computer program product of claim 1, wherein the determining of the license is performed using the user inputs to the repository, and wherein the user inputs comprise at least one of further uploaded data analysis functions to the repository, feedbacks of the data analysis functions in the repository, and changes to the data analysis functions in the repository.

25. The computer program product of claim 1, further comprising, in response to receiving a user input comprising a piece of code, running a similarity check for determining if the received piece of code is not a duplicate of an existing code of the repository; and based on the result of the comparison defining or updating the license for the user.

26. The computer program product of claim 1, wherein the certifying is performed using a certificate-based digital signature to sign the executable code.

27. The computer program product of claim 1, further comprising receiving from the user data indicative of the run-time environment, wherein the compiling is performed in response to receiving that data.

28. The computer program product of claim 1, wherein the data analysis functions comprise data classifiers or data rules.

29. A computer system for creating run-time executables for data analysis functions, the computer system being configured for:
in response to receiving a data analysis request from a user, selecting from the repository a set of data analysis functions for execution in a hosting environment or on premises of the user;
determining a license of the set of data analysis functions for the user for execution of the set of data analysis functions;
creating an additional code for implementing the determined license;
compiling the selected data analysis functions and the additional code, resulting in an executable code;
certifying the executable code; and
deploying the certified executable code or providing the certified executable code for download to a run-time environment for certified executable codes.

30. The computer system of claim 1, further comprising configuring the executable code for enabling a collection of usage statistics of the selected data analysis functions during execution of the executable code.

31. The computer system of claim 1, if according to the license the user is not entitled to use a full functionality of the selected data functions, creating the additional code such that the set of data analysis functions are used with restricted functionalities.

32. The computer system of claim 1, further comprising receiving user feedbacks on the set of data analysis functions, and using the user feedbacks for updating the repository.

33. The computer system of claim 1, wherein the selected set of data analysis functions are at least one of updated data analysis functions of the repository, new added data analysis functions to the repository, and existing data analysis functions of the repository, and wherein the new added analysis function is a function that is added to the repository in a predefined time period, the existing data analysis function is a function that existed before that predefined time period; and the updated analysis function is an existing function that is updated.

34. The computer system of claim 1, wherein the received request is indicative of metadata imported from a data source, and wherein the metadata is indicative of one or more analysis to be performed on data of the data source and providing the metadata as input to at least one predefined machine learning model, and wherein the selected set of data analysis functions is an output of the at least one machine learning model using as input the metadata and the data analysis functions of the repository.
